(19) United States
(12) Patent Application Publication
(10) Pub. No.: US 2002/0046344 A1
(43) Pub. Date: Apr. 18, 2002

(54) Vehicle data rewrite technique

(76) Inventor: Shuichi Naito, Shizuoka (JP)

Correspondence Address: Thomas R. Morrison, Esq., MORRISON LAW FIRM, 140 North Fifth Avenue, Mount Vernon, NY, 10550, US

(21) Appl. No.: 09/924,195

(22) Filed: Aug. 8, 2001

(30) Foreign Application Priority Data
Aug. 31, 2000 (JP) 2000-263071

(51) Int. Cl. G06F 12/14

(52) U.S. Cl. 713/189; 713/193; 711/164

(57) ABSTRACT

An electronic control system includes at least an electronic portion and a security flag portion. Operational data is written or rewritten to the electronic portion according to an external standard requiring at least a time delay before rewriting. A security flag portion allows for updating the electronic portion without the time delay where it identifies one of an incomplete initial data write state and a unwritten data write state. After a successful write to the electronic portion the security flag portion identifies the complete written state and requires the delay time before additional rewriting.

### CROSS-REFERENCE TO RELATED APPLICATIONS

This application is based upon and claims priority of Japanese Patent Application No. 2000-263071, filed Aug. 31, 2000, the contents being incorporated by reference herein.

### BACKGROUND OF THE INVENTION

1. Field of the Invention

The present invention relates to a data rewrite technique, apparatus, and system. More particularly, the present invention relates to an electronic control apparatus, data rewrite system, and method for updating an electronic control apparatus on the basis of an updating standard.

2. Description of the Related Art

Onboard electronic controls are proliferating. For example, onboard electronic controls (not shown) are used in cars for engine, transmission, and brake control. In each case, the onboard electronic control writes, rewrites or updates data, such as internal programs or internal data, that were originally installed at a factory, market, or dealer.

Before shipping a car to market, many of the programs in the onboard electronic control are rewritten at least once. After reaching a destination, many of the same programs must again be rewritten to accommodate upgrades, cope with specifications at a shipment destination, or fix improperly originally installed programs or data.

To rewrite a program in the onboard electronic control, an onboard electronic control apparatus is connected to an external data rewrite apparatus (or service tool) (not shown). To accurately update the onboard electronic control apparatus, the external data rewrite apparatus must be capable of understanding the update instructions and transmitting them to the onboard electronic control apparatus. As an updating standard, it is to be understood, that “ISO (International Organization for Standardization) 14230” [hereinafter ISO14230] standard is known as a communication standard between an onboard electronic control apparatus and a data rewrite apparatus.

Under the ISO14230 standard, to prevent illicit rewriting of an onboard program, a KEY (password) collation/comparison command called a security access is prepared before the program will rewrite. This technique is described in a standard ISO15031-7 (SAEJ2186) as a ‘communication standard for preventing illicit rewrite.’ [hereinafter SAEJ2186]

It is to be understood, that the exhaust gas regulation law in Europe, i.e. “EURO OBD” obliges manufacturers to employ and satisfy the standard of “ISO15031-7 (SAEJ2186)” or higher level to prevent illicit tampering with an onboard program and hence with the electronic control apparatus.

Referring now to FIG. 4, showing the processing flow of rewriting a program in an onboard electronic control apparatus (not shown) by communication between the onboard electronic control apparatus and a data rewrite apparatus (service tool) in accord with communication standard SAEJ2186.

In a first step 501, the onboard electronic control apparatus in a car is powered on by operating the ignition (IG) of the car (to be simply referred to hereafter as “IG power ON”). In a second step 502, the onboard electronic control apparatus begins measuring the elapse time from first step 501. i.e. from the IG power ON time.

In a third step 503, a data rewrite apparatus (service tool) requests the onboard electronic control apparatus to send a data “SEED” that is base data for the KEY (password) calculation.

In a fourth step 504, upon receiving the request of third step 503, the onboard electronic control apparatus transmits a 2-byte “SEED” to the data rewrite apparatus (service tool). It is to be understood that the 2-byte ‘SEED’ is data that takes a random value for every request

In a fifth step 505, the data rewrite apparatus (service tool) calculates a 2-byte KEY (password) using the SEED from the onboard electronic control apparatus, in accordance with a predetermined KEY calculation method, transmits the 2-byte KEY to the onboard electronic control apparatus, and requests the onboard electronic control apparatus to execute KEY collation.

In a sixth step 506, upon receiving the 2-byte KEY (password) from the data rewrite apparatus (service tool), the onboard electronic control apparatus determines whether the elapse time from IG power ON (step 502) (to also be referred to as “delay time” hereinafter) is 10 sec or more.

It is to be understood, that the communication standard SAEJ2186 prescribes a delay time of 10 seconds or more for the first access after IG power ON step 501.

If NO in step 506 is determined, the onboard electronic control apparatus sends to the data rewrite apparatus (service tool) a negative response representing that the onboard electronic control apparatus rejects the KEY (password) collation/comparison. Then, the flow returns to step 505 to repeat processing from step 505.

In a seventh step 507, if YES in step 506, the onboard electronic control apparatus executes the KEY (password) collation/comparison. It is to be understood, that the onboard electronic control apparatus notifies the data rewrite apparatus (service tool) of the result of KEY collation in step 507.

In an eighth step 508, the data rewrite apparatus (service tool) determines whether the KEY collation result is OK or NG (negative or no-go). If NO in step 508, the flow (program) returns to step 503 to cause the data rewrite apparatus (service tool) to resend the SEED request.

In a ninth step 509, if YES in step 508, the data rewrite apparatus (service tool) rewrites the program in the onboard electronic control apparatus.

In a tenth step 510, the data rewrite apparatus (service tool) determines whether the program rewrite in step S509 is normally ended or OK (accepted as a compatible and proper rewrite)

In an eleventh step 511, if NO in step 510, the data rewrite apparatus (service tool) powers off the IG. After that, the processing from step 501 is repeatedly executed.

If YES in step 510, the processing or rewriting is ended.

It is to be understood, therefore, that the communication standard SAEJ2186 prevents illicit rewriting of a program in the market place. The standard does not prevent rewriting or writing of a program before shipment from a factory. Thus, the SAEJ2186 standard is required for any rewriting in the market place (outside the factory) but not before shipment from the factory. It should be therefore understood, that where a first rewrite occurs in the factory, it is not necessary to employ the standard required delay time.

From the second program rewrite onward, a delay time of 10 sec or more from the IG power ON (step 501) time is necessary for the onboard electronic control apparatus to receive and collate a KEY (password) from the data rewrite apparatus.

In the conventional data rewrite method, however, is not normally required to rewrite the program at the factory, and since the SAEJ2186 standard is preinstalled, the delay time is prepared even for the first program rewrite before shipment from the factory. This causes undesirable delay.

For this reason, even when the program in the onboard electronic control apparatus is rewritten on a production line in the factory (i.e. an allowable first program rewrite without delay), the delay time is necessary midway in the operation flow, and accordingly, the factory productivity considerably decreases.

It is to be understood as desirable to find a way that allows avoidance of the delay time during rewriting at the factory while retaining the preinstallation of the program and standard for later rewrite protection.

### OBJECTS AND SUMMARY OF THE INVENTION

In is an object of the present invention to overcome the problems described above.

It is another object of the present invention to provide an apparatus, program, or method capable of efficiently rewrite a program on an electronic control apparatus at a factory without experiencing a delay.

It is another object of the present invention to provide an electronic control apparatus that allows a security flag to bypass a predetermined security feature at a factory while allowing the security feature to be required outside of the factor

It is another object of the present invention to provide an onboard electronic control apparatus, data rewrite system, data rewrite method, program for executing each, and computer-readable storage medium for storing a program effective to efficiently rewrite the onboard electronic control apparatus and avoid the problems described above.

Briefly stated, the present invention provides an electronic control system including at least an electronic portion and a security flag portion. Operational data is written or rewritten to the electronic portion according to an external standard requiring at least a time delay before rewriting. The security flag portion allows updating the electronic portion without the time delay where it identifies either an incomplete initial data write as an unwritten state. After a successful write to the electronic portion the security flag portion identifies the complete written state and requires the delay time before additional rewriting.

According to an embodiment of the present invention there is provided an electronic control system, further comprising: a storage portion, at least a memory portion in the storage portion, at least a security flag portion in the storage portion, the memory portion being in at least one of an initial state and a written state, the written state exiting on a successful writing to the memory portion, the initial state existing on at least one of an unsuccessful writing to the memory portion and an initial state of the memory portion, the security flag portion indicating a status of the memory portion as being in the at least one state, a control portion in controlling communication with the storage portion, and the control portion controlling, on a basis of the status, one of a writing and a rewriting to the memory portion according to an external standard having a delay portion and the control portion bypassing the delay portion when the security flag portion indicates the status as being in the initial state, whereby the writing avoids the delay portion.

According to another embodiment of the present invention there is provided an electronic control system, comprising: an electronic control portion, at least a storage portion in the electronic control portion, the storage portion effective for storing operational data, the storage portion being in one of at least an unwritten state and a written state, the written state existing upon a successful writing to the storage portion, the unwritten state existing upon at least one of an unsuccessful writing to the storage portion and an initial storage portion, means for writing and rewriting to the storage portion according to a security standard requiring at least a delay time before permitting the writing to the storage portion, and security bypass means in the electronic control system for identifying the at least one state and allowing the means for writing and rewriting to bypass the delay time where the unwritten state exists, whereby the means for writing and rewriting can write to the storage portion without the delay time.

According to another embodiment of the present invention there is provided an electronic control system, further comprising: a security flag in the storage portion and the means for writing and rewriting effective to indicate the at least on state, a first control portion in the electronic control portion, a first communication section in the electronic control portion, and the first control portion effective to read the operational data from the storage portion and control the electronic control portion.

According to another embodiment of the present invention there is provided an electronic control system, further comprising: a second control portion in the data rewrite portion, a second communication section in the data rewrite portion, and the second control portion effective to receive the operational data and transmit the operational data from the second communication section to the first communication system, whereby the electronic control portion is easily updated.

According to another embodiment of the present invention there is provided an electronic control system, wherein the means for writing and rewriting further comprises: first means for setting a process flag in the storage portion representing the at least one state, second means for causing the electronic control portion to start measuring a delay time, third means for causing the data rewrite portion to request a seed data from the electronic control portion, fourth means for causing the electronic control portion to return the seed portion to the data rewrite portion, fifth means for causing the data rewrite portion to calculate a security password based upon the seed and transmit the security password to the electronic control portion, sixth means for causing the electronic control portion to review the process flag, first means requiring the electronic control portion to collate the security password when the process flag indicates the unwritten state, second means for requiring the electronic control portion to require the predetermined delay time when the process flag indicates the written state, means for writing to the storage portion, means for determining whether the writing is complete, and means for updating the process flag upon the complete writing into the storage portion, whereby the process flag represents the other of the state.

According to another embodiment of the present invention there is provided an electronic control system, comprising: a control portion, a data rewrite portion in communication with the control portion, at least a storage portion in the control portion, the storage portion effective for storing operational data and being in one of at least an unwritten and a written state wherein the written state exists upon a successful input of the operational data, means for writing the operational data from the data rewrite portion to the storage portion according to a security standard requiring at least a password calculation, a password collation, and a delay time before the means for writing may write to the storage portion, and security bypass means in the electronic control system for identifying the one of the unwritten state and the written state and allowing the means for writing and rewriting to bypass the delay time when the unwritten state exists.

According to another embodiment of the present invention there is provided an electronic control apparatus subject to a delay time requirement during complete updates, comprising: an electronic control portion in the electronic control apparatus, an external data rewrite portion in updating communication with the electronic control portion effective to update the electronic control portion, at least a storage portion in the electronic control portion, the storage portion effective for storing operational data, the storage portion being in one of at least an unwritten and a written state, the written state existing upon a successful input of the operational data, means for writing and rewriting the operational data from the external data rewrite portion to the storage portion according to a security standard requiring at least a predetermined delay time before permitting writing of the operational data to the storage portion, and security bypass means in the electronic control apparatus for identifying the one of the unwritten state and the written state and allowing the means for writing and rewriting to bypass the predetermined delay time when the unwritten state exists, whereby the means for writing and rewriting can write the operational data to the storage portion quickly.

According to another embodiment of the present invention there is provided a method of writing and rewriting operational data to an electronic control apparatus subject to a delay time standard, comprising the steps of: setting a security flag in the electronic control apparatus to represent a state where operational data has not been correctly written a first time to the electronic control apparatus, causing the electronic control apparatus to initiate a power on state, sending operational data from a rewrite apparatus to the electronic control apparatus, causing the electronic control bypass the delay time standard where the security flag indicates that the operational data has not been correctly written a first time, writing the operational data into a memory portion of the electronic control apparatus, causing the electronic control apparatus to decide if the writing was successful and complete, where the writing was successful and complete, setting the security flag to indicate a correctly written update thereby causing future updates to undergo the delay time, and where the writing was unsuccessful, maintaining the security flag without change to avoid the delay time.

According to another embodiment of the present invention there is provided an onboard electronic control apparatus comprising: a storage unit, an external data rewrite system, the storage unit allowing data written in one of an initial state and a written state to be rewritten in accordance with a predetermined data rewrite standard by communication with the external data rewrite apparatus, a processing flag in the storage unit representing whether the storage unit is in one of the initial state and the written state, a control unit in controlling communication with the storage unit, the control unit controlling the storage unit on a basis of the processing flag effective to allow a first successful data write to the storage unit in the initial state and bypassing a predetermined rewrite standard, and effective to allow a rewrite of the data in the storage unit in the written state according to the predetermined rewrite standard.

According to another embodiment of the present invention there is provided an onboard electronic control apparatus wherein: the predetermined data rewrite standard defines a predetermined delay time for a security access from the data rewrite apparatus, and when the processing flag represents that the storage unit is in the initial state, the control unit executes a data rewrite processing without a delay time.

According to another embodiment of the present invention there is provided a data rewrite system in which an electronic control apparatus and a data rewrite apparatus are in communication, and the electronic control apparatus comprises: a storage unit in which operational data is written in an initial state and the operational data is rewritten in accordance with a predetermined data rewrite standard by communication with the external data rewrite apparatus, a processing flag representing whether the storage unit is in the initial state, and a control unit for controlling, on the basis of the processing flag, a first data write in the storage unit in the initial state and a rewrite of the operational data in the storage unit in accordance with the predetermined data rewrite standard.

According to another embodiment of the present invention there is provided a data rewrite system, wherein: after the data write in the initial state is successful, the control unit sets the processing flag to represent that the storage unit is not in the initial state.

According to another embodiment of the present invention there is provided a data rewrite system, wherein: the predetermined data rewrite standard defines a predetermined delay time for a security access from the data rewrite apparatus, and when the processing flag represents that the storage unit is in the initial state, the control unit executes the data rewrite processing without the delay time.

According to another embodiment of the present invention there is provided a data rewrite method of rewriting data in an electronic control apparatus in a vehicle by a data rewrite apparatus outside the vehicle, comprising: setting a processing flag to represent that no first data write in the electronic control apparatus is executed, controlling, when a first data write in the electronic control apparatus is executed by communication between the electronic control apparatus and the data rewrite apparatus, the setting of the processing flag to represent that the first data write is executed, executing the first data write in the electronic control apparatus on a basis of setting of the processing flag, and rewriting the data which has already been written in the electronic control apparatus in accordance with a predetermined data rewrite standard on the basis of setting of the processing flag.

According to another embodiment of the present invention there is provided a data rewrite method, wherein the setting step comprises a step of setting the processing flag after an end of the data write.

According to another embodiment of the present invention there is provided a program for rewriting data in an electronic control apparatus in a vehicle by a data rewrite apparatus outside the vehicle, the program causing a computer to execute the following steps: setting a processing flag to represent that no first data write in the electronic control apparatus is successfully executed, controlling, when the first data write in the electronic control apparatus is executed by communication between the electronic control apparatus and the data rewrite apparatus, a setting of the processing flag to represent that a first data write is executed, executing the first data write in the electronic control apparatus on a basis of setting of the processing flag, and rewriting the data previously written in the electronic control apparatus in accordance with a predetermined data rewrite standard on the basis of setting of the processing flag.

According to another embodiment of the present invention there is provided a program for rewriting data wherein the setting step comprises a step of setting the processing flag after an end of the data write.

According to another embodiment of the present invention there is provided a computer-readable recording medium which stores a program for rewriting data in an electronic control apparatus in a vehicle rewrite-able by a data rewrite apparatus outside the vehicle, the program causing a computer to execute the steps of: setting a processing flag to represent that no first data write in the electronic control apparatus is executed, setting, when the first data write in the electronic control apparatus is executed by communication between the electronic control apparatus and the data rewrite apparatus, the processing flag to represent that the first data write is executed, executing the first data write in the electronic control apparatus on a basis of setting of the processing flag, and rewriting the data, previously written in the electronic control apparatus in accordance with a predetermined data rewrite standard and on the basis the processing flag.

According to another embodiment of the present invention there is provided a computer recordable medium, wherein: the setting step comprises a step of setting the processing flag after an end of the data write.

According to another embodiment of the present invention there is provided a method for eliminating a time delay in initial programming of an electronic control system, comprising the steps of: setting a flag to 0 in a new electronic control system, detecting the 0 during a first run of the electronic control system to produce a reset signal, setting the flag to 1 in response to the reset signal, applying the 1 to all subsequent runs of the electronic control system, and applying a predetermined time delay only in response to the 1, and applying zero time delay in response to the 0.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a simplified schematic diagram of a data rewrite system according to an embodiment of the present invention.

FIG. 2 is a block diagram showing the functional arrangement of a data rewrite system according to the present invention.

FIG. 3 is a flow chart explaining the operation of the data rewrite system.

FIG. 4 is a flow chart explaining a conventional program rewrite system.

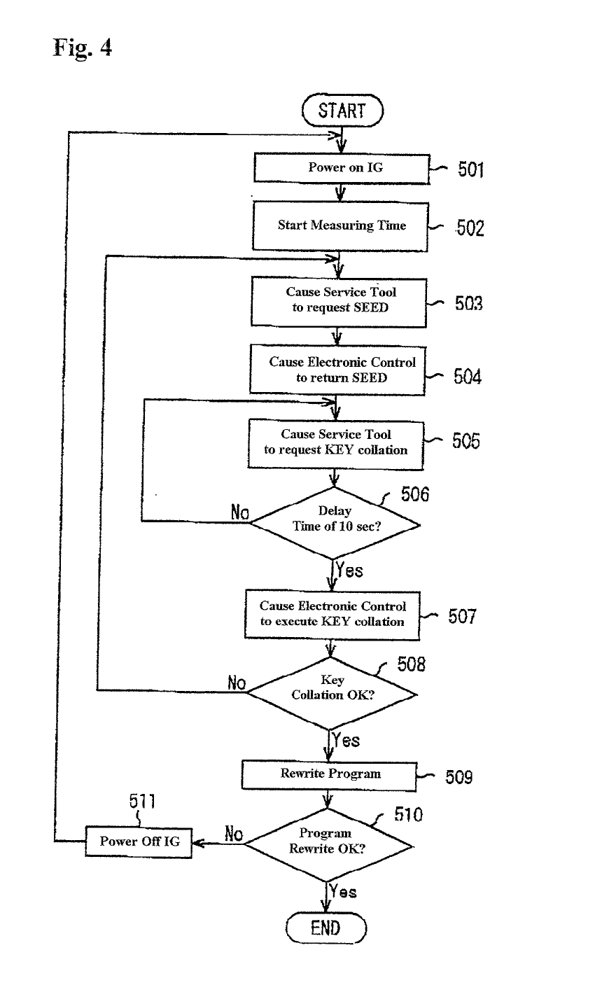

### DETAILED DESCRIPTION OF THE INVENTION

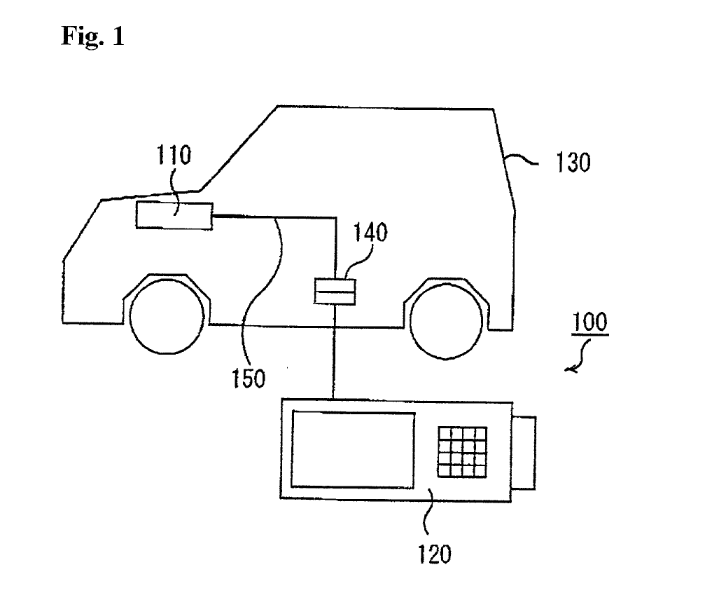

Referring now to FIG. 1 a data rewrite system 100 includes an electronic control apparatus 110, retained in an vehicle 130, joined to a rewrite apparatus 120. Rewrite apparatus 120 is to be understood as an external apparatus.

It is to be further understood, that vehicle 130 is not restricted to the car outline as shown, but may be any apparatus including an electronic control and requiring update to an internal program. For example, the apparatus maybe any one or more of the following, a boat, an aircraft, a motorcycle, a forklift, commercial equipment, construction equipment, recreational equipment, or stationary equipment.

Data rewrite system 100 is designed to write or rewrite, as directed by rewrite apparatus 120, programs, data, or information in electronic control apparatus 110. It is to be understood, that the rewriting is to be in accordance with a communication standard for illicit rewrite prevention, i.e. ISO15031-7 (SAEJ2186).

A communication line 150 connects to electronic control apparatus 110 through a connector 140, to rewrite apparatus 102. It is to be understood, that to write or rewrite an initial program (for example, a program controlling parts of an engine or transmission) data rewrite system 100 connects to rewrite apparatus 120 as an external device and complies with a communication standard. i.e. standard SAEJ1962.

Upon connection, data rewrite system 100 and rewrite apparatus 120 may exchange data through communication line 150. Communicator line 150 may be any communication link (serial, parallel, optical, wireless, infrared etc.) sufficient to meet the needs of data rewrite system 100.

Here, rewrite apparatus 120 operates as a service tool and is prepared in a factory to diagnose malfunctions in vehicle 130 and to write or rewrite programs so as to reduce the cost of repair. Rewrite apparatus 120 is designed to minimize long term tool and development costs. Rewrite apparatus 120 is an automotive repair tool as shown here, but is to be understood to be any external apparatus capable of communicating with and rewriting programs on electronic apparatus 110 according to the applicable communication standards.

It is to be understood that in any service tool (e.g., a computer) prepared to diagnose malfunctions, malfunction diagnosis software is installed in advance and can be activated at need. In addition, software for executing the functions of rewrite apparatus 120 is also installed and can be activated at need. For this reason, no separate service tools need be prepared for malfunction diagnosis and program rewrite, and operational and repair efficiency improves considerably.

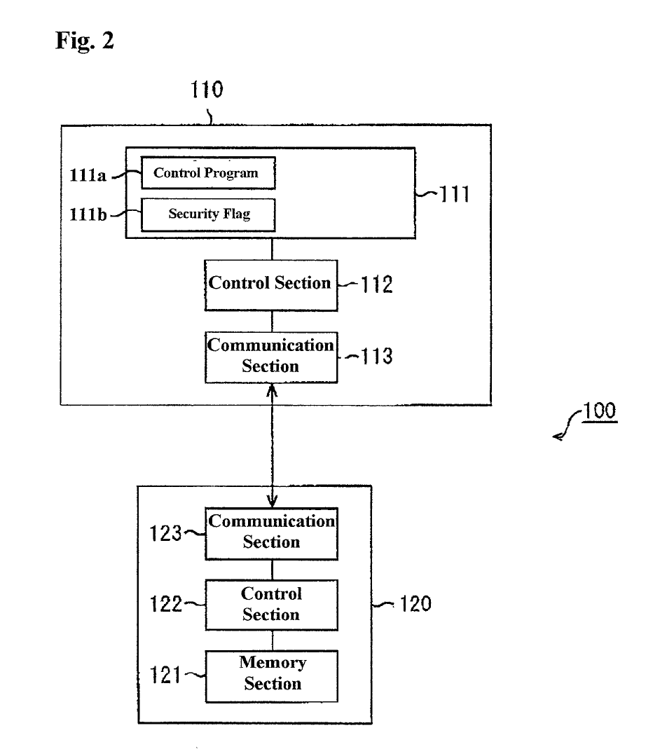

Additionally referring now to FIG. 2, a functional arrangement for data rewrite system 100 includes a control section (e.g., a CPU) 112 for controlling the operation of electronic control apparatus 110. Electronic control apparatus 110 includes a memory 111 which stores a program 111a (to be rewritten), a security flag 111b, and additional processing programs (not shown) for executing operational control by control section 112. Electronic control apparatus 110 further includes a communication section 113 allowing communication with rewrite apparatus 120.

It should be understood, that a skilled artisan, upon reviewing and understanding the complete disclosure will understand how to program the requisite logic elements into a control system and data rewrite system 100.

Rewrite apparatus 120 includes a control section (e.g., a CPU) 122 for controlling the operation of rewrite apparatus 120, and a memory section 121 which stores various processing programs for executing operation control by control section 122. Rewrite apparatus 120 also includes a communication section 123 to allow communication with electronic control apparatus 110.

A delay time (of 10 sec or more) after an IG power ON step (described later), defined by the communication standard (here SAEJ2186) for illicit rewrite prevention is unnecessary when program 111a is written in electronic control apparatus 110 for the first time (installation). Under the standard, the delay time is necessary when program 111a (already written in electronic control apparatus 110) is rewritten in the market place outside the factory. i.e. by a first, second, or third program rewrite.

It is to be understood, as convenient to install (write for the first time) the programs according to the standard into memory 111 at the factory. This means that the required delay time/security measure is also installed and must be dealt with in any subsequent rewrites, even if they occur at the factory. Consequently, the delay time is prepared even for the first program rewrite which is undesirable in the factory process where first time installation errors occurs or rapid production line changes must be made. It is to be understood as desirable to avoid the requirement of the delay time during subsequent factory-based rewrites in memory 111.

According to the present embodiment, security flag 111b is prepared in memory 111, and is determined by referring to a value set in security flag 111b as to whether the delay time is to be prepared. Security flag 111b represents whether memory 111 is in a state before program 111a is written (as will be explained). Security flag 111b may be referred to as either a “0” or a “1,” depending upon write-status, as will be described.

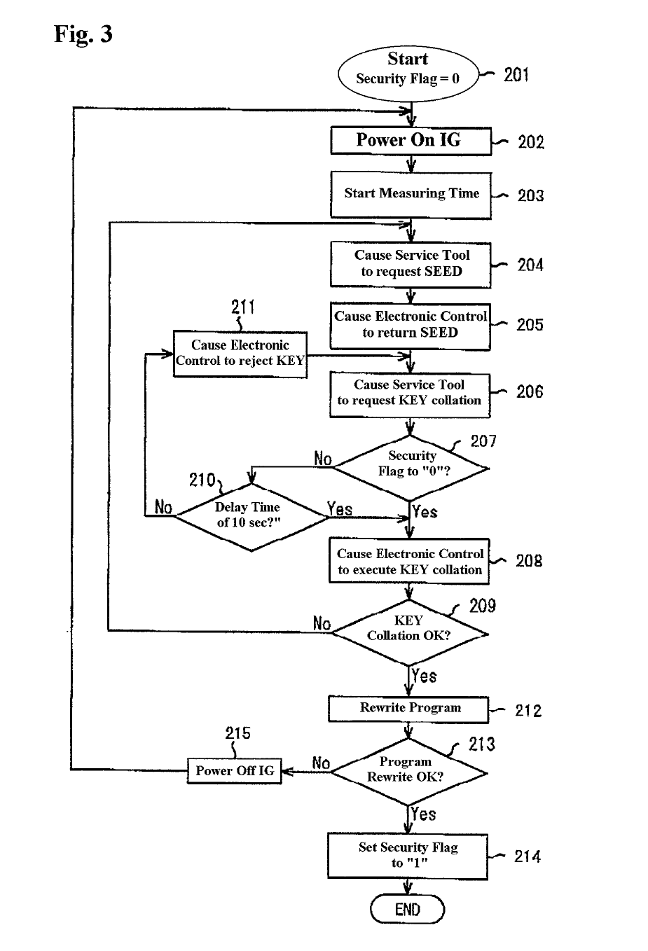

Additionally referring now to FIG. 3, showing the processing flow of rewriting program 111a in electronic control apparatus 110, according to one of the present embodiments.

For example, when control section 112 in electronic control apparatus 110 reads out and executes a processing program corresponding, to the flow chart in FIG. 3, which is stored in memory 111 in advance, the control section 122 in rewrite apparatus 120 also reads out and executes a processing program corresponding to (and supporting) the flow chart in FIG. 3, which is stored in memory 121 in advance, whereby the following operation is executed.

According to the present embodiment, in a first step 201, security flag 111b is set to “0” in the initial step. “0” represents an initial memory 111 state before program 111a is written into. It is to be understood, that when security flag 111b is “0”, rewrite (or write) processing of program 111a is executed without any delay time (10 sec. in this standard) from an IG power ON step to a KEY collation step (both described later) by a security access, as will be described. It is to be further understood, that when security flag 111b is “1”, program rewrite processing is executed with a delay time and complies with a communication standard, for example standard SAEJ2186.

In a second step 202, the IG (ignition) is powered on. [referred to as IG power ON step]

In a third step 203, electronic control apparatus 110 starts measuring the elapse time from IG power ON, second step 202.

In a fourth step 204, rewrite apparatus 120 requests that electronic control apparatus 110 send data [hereinafter called “SEED”] that is a base data for KEY (password) calculation.

In a fifth step 205, upon receiving the request in fourth step 204, electronic control apparatus 110 transmits 2-byte SEED (data that takes a random value for every request) to rewrite apparatus 120.

In a sixth step 206, rewrite apparatus 120 calculates a 2-byte KEY using the SEED from electronic control apparatus 110 in accordance with a predetermined KEY calculation method and transmits the 2-byte KEY(password) to electronic control apparatus 110, thereby requesting that electronic control apparatus 110 execute KEY collation/comparison.

In a seventh step 207, upon receiving the KEY collation request from rewrite apparatus 120, electronic control apparatus 110 determines whether or not security flag 111b is “0.”

In an eighth step 210, if ‘NO’ in step 207 (i.e. a value other than 0), electronic control apparatus 110 determines whether the elapse time from the IG power ON time is 10 sec. or more (as a security check under the applied standard).

In a ninth step, 211, if NO in step 210 and time is not 10 sec. or more, electronic control apparatus 110 sends to rewrite apparatus 120 a negative response representing that electronic control apparatus 110 rejects the KEY collation. Then, the flow returns to sixth step 206 to repeat processing.

In a tenth step 208, if either YES in step 210, or if YES in step 207, electronic control apparatus 110 executes the KEY (password) collation/comparison. Thus, when security flag 111b is “0”, electronic control apparatus 110 does not execute delay time determination processing, and the flow directly advances to step 208 to execute KEY collation without delay and speeding operations. It is to be understood, that electronic control apparatus 110 notifies rewrite apparatus 120 of the result of KEY collation in step 208.

In an eleventh step 209, rewrite apparatus 120 determines whether the KEY collation result is OK or NG (no go).

If NO in step 209, the flow returns to step 204 to cause rewrite apparatus 120 to send the SEED (base data) request.

In a twelfth step 212, If YES in step 209, rewrite apparatus 120 rewrites program 111a in electronic control apparatus 110.

In a thirteenth step 213, rewrite apparatus 120 determines whether the rewrite of program 11a in step 212 is normally ended.

In a fourteenth step, 214, if NO in step 213, rewrite apparatus 120 powers off the IG. After that, the processing from step 202 is repeatedly executed.

If YES in step 213, rewrite apparatus 120 notifies electronic control apparatus 110 of positive results, i.e. whether the rewrite was normally ended.

In a fifteenth step 214, after a YES in step 213, electronic control apparatus 110 sets security flag 111b to “1” indicating that a rewrite has occurred.

Then, the processing is ended.

As described above, in the present embodiment security flag 111b is prepared and when set to “0”, the delay time defined by a standard, for example standard SAEJ2186 is omitted, and when security flag 111b is set to “1”, the delay time is employed.

With this arrangement, in the second or subsequent program rewrite (the first being the initial program writing, which does require communication standard SAEJ2186), program rewrite processing including the delay time is executed. In the first program rewrite, which does not require communication standard SAEJ2186, program rewrite processing without the delay time is executed without delay. Further, where the first program rewrite is inadequate, security flag 111b is not inappropriately set to 1, further delaying correction. That is, program 111a in electronic control apparatus 110 may be efficiently rewritten in accordance with an operational situation.

It is to be understood, that as an additional benefit according to the present invention, where an initial rewrite (in the factory) is in error, unsuccessful, or not ‘OK’ in step 213, security flag 111b is not set to 1, and operators at the factory can easily correct the problem without the delay time.

It is to be understood, that writing or updating a faulty initial write with forced delay time is prevented midway in the operation flow (as required in the conventional art) before shipment from the factory, and hence, the factory productivity increases.

It is to be understood, that security flag 111b may be set to “1”, e.g. before or after KEY collation. In this embodiment, as allowed by the standard, only when the rewrite of program 111a is normally ended and the result is OK is security flag 111b set to “1”.

With this arrangement, when write (rewrite) processing for a program before shipment from a factory fails and the rewrite processing must be executed a second or third time before a successful result, the rewrite processing without the delay time for the ‘first’ program rewrite (i.e. first successful complete rewrite) can be executed, and operational efficiency considerably improves.

Further, in this embodiment a processing flag is prepared in electronic control apparatus 110, and on the basis of the set contents of a processing flag, the first data write (first program rewrite) and any subsequent data rewrite (second or subsequent program rewrite) in electronic control apparatus 110, are executed that comply with a predetermined data rewrite standard.

For example, when the predetermined data rewrite standard is the standard “ISO15031-7 (SAEJ2186) for illicit rewrite prevention, requiring a predetermined delay time for security access and rewrites, data rewrite processing without the delay time can be executed before shipment from the factory, and data rewrite processing including the delay time can be executed in the second or subsequent data rewrite for upgrading in the market.

That is, the rewrite processing for the data in electronic control apparatus 110 can be efficiently executed depending on the situation before shipment when a particular data rewrite system 100 is under manufacture control. Since the data rewrite processing without the delay time can be executed in the data rewrite (data write) before shipment from the factory, factory production can be efficiently done.

In the present embodiment it is to be understood that data rewrite system 100 is designed such that security flag 111b is set to indicate that the first data write (first data rewrite) in electronic control apparatus 110 is successfully ended. Thus, even when the rewrite processing for a data rewrite (data write) before shipment from the factory fails and the rewrite processing must be executed again, the first data write process (first successful data rewrite) in electronic control apparatus 110 can be reliably executed without delay.

The above embodiment is a mere embodiments of the present invention and should not be construed to limit the technical range of the present invention as claimed. That is, the present invention can be practiced in various forms without departing from its technical spirit and scope of the invention.

It is to be understood, that electronic control apparatus 110 is not limited to an engine control apparatus or to automatic transmission control apparatus but may be any other control apparatus such as a traction control (TCL) control unit, ABS (Anti-lock Brake System) control unit, or power steering control unit useful in many embodiments.

It is to be understood, that one of the objects of the present invention may also be achieved by supplying a storage medium which stores software program codes for implementing the functions of a host and a terminal of the above embodiment into a system or apparatus and causing the computer (or CPU or MPU) of the system or apparatus to read out and execute the program codes stored in the storage medium. It is to be understood, that in this case, the program code read from the storage medium implements the functions of the embodiment by themselves.

As the storage medium for supplying the program codes, a ROM, floppy disk, hard disk, optical disk, magneto-optical disk, CD-ROM, CD-R, magnetic tape, or nonvolatile memory card may be used.

It is to be understood, that the functions of the embodiment are implemented not only when the readout program codes (not shown) are executed by electronic control apparatus 110, but also when the operating system running on control section 112 (the computer) performs part or all of actual processing on the basis of the instructions of the program codes.

It is to be understood, that the functions of the embodiment are also implemented when the program codes, read from the storage medium are written in a memory of a function expansion board (not shown) inserted into a function expansion unit (not shown) connected to the above computer, and the CPU of the function expansion board or function expansion unit performs part or all of actual processing on the basis of the instructions of the program codes.

It is to be understood, that the above embodiment can be implemented by causing a computer to execute a program. A unit for supplying the program to the computer, e.g., a recording medium such as a CD-ROM which records the program or a transmission medium such as the Internet which transmits the program can also be applied as an embodiment of the invention. The program, recording medium, and transmission/communication medium are incorporated in the present invention.

It is to be understood, that an ‘unwritten state’ for said security flag 111b is an incorrectly written state such that the security flag is still set to ‘0’ and is only set to ‘1’ upon complete and correct rewriting.

It should be further understood, that where the characters 0 or 1 are used as reference characters, a simple inversion of each or application of other mathematical operation, does not change the operation of the present invention since the characters are to be understood as representational in essence.

Although only a single or few exemplary embodiments of this invention have been described in detail above, those skilled in the art will readily appreciate that many modifications are possible in the exemplary embodiment(s) without materially departing from the novel teachings and advantages of this invention. Accordingly, all such modifications are intended to be included within the scope of this invention as defined in the following claims. In the claims, means-plus function clauses are intended to cover the structures described or suggested herein as performing the recited function and not only structural equivalents but also equivalent structures. Thus although a nail and screw may not be structural equivalents in that a nail relies entirely on friction between a wooden part and a surface whereas a screw's helical surface positively engages the wooden part, in the environment of fastening wooden parts, a nail and a screw may be equivalent structures.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. An electronic control apparatus, comprising:
a storage portion;
a memory portion in said storage portion;
a security flag portion in said storage portion;
said memory portion being in at least one of an initial state and a written state;
said written state exiting on a successful writing to said memory portion;
said initial state existing on at least one of an unsuccessful writing to said memory portion and an unwritten state of said memory portion;
said security flag portion indicating a status of said memory portion as being in said at least one state;
a control portion for controlling communication with said storage portion;
said control portion including means for controlling, on a basis of said status, one of a writing and a rewriting to said memory portion according to an external standard having a delay portion; and
said control portion further including means for bypassing said delay portion when said security flag portion indicates said status as being in said initial state, whereby said control portion avoids said delay portion.

2. An electronic control system, comprising:
an electronic control portion;
a storage portion in said electronic control portion;
said storage portion effective for storing operational data;
said storage portion being in one of at least an unwritten state and a written state;
first means for setting said written state as a first status existing upon a successful writing to said storage portion;
second means for setting said unwritten state as a second status existing upon at least one of an unsuccessful writing to said storage portion and an initial storage portion;
means for writing and rewriting to said storage portion according to a security standard requiring at least a delay time before permitting said writing to said storage portion; and
security bypass means in said electronic control system for identifying said at least one state and allowing said means for writing and rewriting to bypass said delay time where said unwritten state exists, whereby said means for writing and rewriting can write to said storage portion without said delay time.

3. An electronic control system, according to claim 2, further comprising:
a security flag in said storage portion and said means for writing and rewriting effective to indicate said at least on state;
a first control portion in said electronic control portion;
a first communication section in said electronic control portion; and
said first control portion effective to read said operational data from said storage portion and control said electronic control portion.

4. An electronic control system, according to claim 3, further comprising:
a second control portion in said data rewrite portion;
a second communication section in said data rewrite portion; and
said second control portion effective to receive said operational data and transmit said operational data from said second communication section to said first communication system, whereby said electronic control portion is easily updated.

5. An electronic control system according to claim 4, wherein said means for writing and rewriting further comprises:
first means for setting a process flag in said storage portion representing said at least one state;
second means for causing said electronic control portion to start measuring a delay time;
third means for causing said data rewrite portion to request a seed data from said electronic control portion;
fourth means for causing said electronic control portion to return said seed portion to said data rewrite portion;
fifth means for causing said data rewrite portion to calculate a security password based upon said seed and transmit said security password to said electronic control portion;
sixth means for causing said electronic control portion to review said process flag;
first means requiring said electronic control portion to collate said security password when said process flag indicates said unwritten state;
second means for requiring said electronic control portion to require said predetermined delay time when said process flag indicates said written state;
means for writing to said storage portion;
means for determining whether said writing is complete; and
means for updating said process flag upon said complete writing into said storage portion, whereby said process flag represents said other of said state.

6. An electronic control system, comprising:
a control portion;
a data rewrite portion in communication with said control portion;
at least a storage portion in said control portion;
said storage portion effective for storing operational data and being in one of at least an unwritten and a written state wherein said written state exists upon a successful input of said operational data;
means for writing said operational data from said data rewrite portion to said storage portion according to a security standard requiring at least a password calculation, a password collation, and a delay time before said means for writing may write to said storage portion; and
security bypass means in said electronic control system for identifying said one of said unwritten state and said written state and allowing said means for writing and rewriting to bypass said delay time when said unwritten state exists.

7. An electronic control apparatus subject to a delay time requirement during complete updates, comprising
an electronic control portion in said electronic control apparatus;
an external data rewrite portion in updating communication with said electronic control portion effective to update said electronic control portion;
at least a storage portion in said electronic control portion;
said storage portion effective for storing operational data;
said storage portion being in one of at least an unwritten and a written state;
said written state existing upon a successful input of said operational data;
means for writing and rewriting said operational data from said external data rewrite portion to said storage portion according to a security standard requiring at least a predetermined delay time before permitting writing of said operational data to said storage portion; and
security bypass means in said electronic control apparatus for identifying said one of said unwritten state and said written state and allowing said means for writing and rewriting to bypass said predetermined delay time when said unwritten state exists, whereby said means for writing and rewriting can write said operational data to said storage portion quickly.

8. A method of writing and rewriting operational data to an electronic control apparatus subject to a delay time standard, comprising the steps of:
setting a security flag in said electronic control apparatus to represent a state where operational data has not been correctly written a first time to said electronic control apparatus;
causing said electronic control apparatus to initiate a power on state;
sending operational data from a rewrite apparatus to said electronic control apparatus;
causing said electronic control bypass said delay time standard where said security flag indicates that said operational data has not been correctly written a first time;
writing said operational data into a memory portion of said electronic control apparatus;
causing said electronic control apparatus to decide if said writing was successful and complete;
where said writing was successful and complete, setting said security flag to indicate a correctly written update thereby causing future updates to undergo said delay time; and
where said writing was unsuccessful, maintaining said security flag without change to avoid said delay time.

9. An onboard electronic control apparatus comprising:
a storage unit;
an external data rewrite system;
said storage unit allowing data written in one of an initial state and a written state to be rewritten in accordance with a predetermined data rewrite standard by communication with said external data rewrite apparatus;
a processing flag in said storage unit representing whether said storage unit is in one of said initial state and said written state;
a control unit in controlling communication with said storage unit;
said control unit controlling said storage unit on a basis of said processing flag effective to allow a first successful data write to said storage unit in said initial state and bypassing a predetermined rewrite standard, and effective to allow a rewrite of said data in said storage unit in said written state according to said predetermined rewrite standard.

10. An apparatus according to claim 9, wherein:
said predetermined data rewrite standard defines a predetermined delay time for a security access from said data rewrite apparatus; and
when said processing flag represents that said storage unit is in said initial state, said control unit executes a data rewrite processing without a delay time.

11. A data rewrite system in which an electronic control apparatus and a data rewrite apparatus are in communication, and said electronic control apparatus comprises:
a storage unit in which operational data is written in an initial state and said operational data is rewritten in accordance with a predetermined data rewrite standard by communication with said external data rewrite apparatus;
a processing flag representing whether said storage unit is in said initial state; and
a control unit for controlling, on the basis of said processing flag, a first data write in said storage unit in said initial state and a rewrite of said operational data in said storage unit in accordance with said predetermined data rewrite standard.

12. A system according to claim 11, wherein:
after said data write in said initial state is successful, said control unit sets said processing flag to represent that said storage unit is not in said initial state.

13. A system according to claim 11, wherein:
said predetermined data rewrite standard defines a predetermined delay time for a security access from said data rewrite apparatus; and
when said processing flag represents that said storage unit is in said initial state, said control unit executes said data rewrite processing without said delay time.

14. A data rewrite method of rewriting data in an electronic control apparatus in a vehicle by a data rewrite apparatus outside said vehicle, comprising:
setting a processing flag to represent that no first data write in said electronic control apparatus is executed;
controlling, when a first data write in said electronic control apparatus is executed by communication between said electronic control apparatus and said data rewrite apparatus, the setting of said processing flag to represent that said first data write is executed;
executing said first data write in said electronic control apparatus on a basis of setting of said processing flag; and
rewriting said data which has already been written in said electronic control apparatus in accordance with a predetermined data rewrite standard on said basis of setting of said processing flag.

15. A method according to claim 14, wherein said setting step comprises a step of setting said processing flag after an end of said data write.

16. A program for rewriting data in an electronic control apparatus in a vehicle by a data rewrite apparatus outside said vehicle, said program causing a computer to execute the following steps:
setting a processing flag to represent that no first data write in said electronic control apparatus is successfully executed;
controlling, when said first data write in said electronic control apparatus is executed by communication between said electronic control apparatus and said data rewrite apparatus, a setting of said processing flag to represent that a first data write is executed;
executing said first data write in said electronic control apparatus on a basis of setting of said processing flag; and
rewriting said data previously written in said electronic control apparatus in accordance with a predetermined data rewrite standard on said basis of setting of said processing flag.

17. A program according to claim 16, wherein said setting step comprises a step of setting said processing flag after an end of said data write.

18. A computer-readable recording medium which stores a program for rewriting data in an electronic control apparatus in a vehicle rewrite-able by a data rewrite apparatus outside said vehicle, said program causing a computer to execute the steps of:
setting a processing flag to represent that no first data write in said electronic control apparatus is executed;
setting, when said first data write in said electronic control apparatus is executed by communication between said electronic control apparatus and said data rewrite apparatus, said processing flag to represent that said first data write is executed;
executing said first data write in said electronic control apparatus on a basis of setting of said processing flag; and
rewriting said data, previously written in said electronic control apparatus in accordance with a predetermined data rewrite standard and on said basis said processing flag.

19. A medium according to claim 18, wherein:
said setting step comprises a step of setting said processing flag after an end of said data write.

20. A method for eliminating a time delay in initial programming of an electronic control system, comprising the steps of:
setting a flag to 0 in a new electronic control system;
detecting said 0 during a first run of said electronic control system to produce a reset signal;
setting said flag to 1 in response to said reset signal;
applying said 1 to all subsequent runs of said electronic control system; and
applying a predetermined time delay only in response to said 1, and applying zero time delay in response to said 0.
